(19) United States
(12) Patent Application Publication
(10) Pub. No.: US 2012/0093594 A1
(43) Pub. Date: Apr. 19, 2012

(54) FACE MILLING CUTTER

(75) Inventor: Peter Kirchberger, Haag (AT)

(73) Assignee: BOEHLERIT GMBH & CO. KG., Kapfenberg (AT)

(21) Appl. No.: 13/375,382

(22) PCT Filed: Jun. 21, 2010
(86) PCT No.: PCT/AT2010/000226

§ 371 Date: Nov. 30, 2011

(30) Foreign Application Priority Data
Jul. 8, 2009 (AT) A 1067/2009

(51) Int. Cl. B23C 3/06; B23C 5/20; B23C 5/06

(52) U.S. Cl. 407/42; 29/6.01; 409/132

(57) ABSTRACT

The invention relates to an end mill (1) for processing a bearing region of a crankshaft, in particular a crankshaft of a ship's engine, with a base body (2) with an end face (3) and several inserts (4) designed for a turn milling, which are arranged on or in the end face (3). In order to achieve favorable chip removal conditions with low cutting forces and thus a low tool load, it is provided according to the invention that the inserts (4) each have at least one cutting edge which comprises alternately active cutting regions and non-active cutting regions.

The invention relates to an end mill for processing a bearing region of a crankshaft, in particular a crankshaft of a ship's engine, with a base body with an end face and several inserts designed for a turn milling, which are arranged on or in the end face.

Furthermore, the invention relates to a use of an insert for an end mill for machining a bearing region of a crankshaft, in particular a crankshaft of a ship's engine.

Finally, the invention relates to a method for machining a bearing region of a crankshaft, in particular a crankshaft of a ship's engine, wherein an end mill is placed against a clamped crankshaft in rotation, in order to machine a bearing region of a predetermined dimension through a turn milling.

Large crankshafts with a length of several meters, for example, crankshafts of ship's engines, can be produced from freeform forgings, wherein up to 50% of a mass of the forgings or blanks has to be removed by chip removal methods in order to produce large crankshafts with a desired contour. Alternatively, a so-called single stroke forging, e.g., according to Tadeusz Rut, for producing blanks for large crankshafts for ships' engines are used, wherein the correspondingly produced blanks likewise are produced in an oversized manner and require a chip removal.

A machining of a blank of a large crankshaft is carried out as a rule by rough machining, which is followed by a turn milling and finally a grinding of the large crankshaft. In this context, according to the prior art so-called 5-axis machines are known, with which a turn milling and at best also an upstream rough machining processing can be carried out. In this regard with respect to a production of crankshaft main bearings or rod bearings, a use of end mills on 5-axis machines is known, which are equipped with a multiplicity of inserts, which respectively have a straight cutting edge. However, it is a disadvantage with these end mills that with the straight cutting edges a relatively flat and long cutting into the material takes place, even if a positive back rake angle is given. This means the chip removal conditions and chip cross-sections are very unfavorable. In particular, large friction forces must be overcome, which entails a corresponding heat development at the inserts. Furthermore, large cutting forces are thereby required, which lead to a marked deformation of the workpiece to be processed and to a high stress of the end mill or processing machines. A further disadvantage is given in that, due to the large friction forces, the end mills can be equipped with inserts only in ring-shaped partial regions with respect to a total end face that is generally circular, because otherwise the cutting forces would be too great. This means that the end mills with inserts with straight cutting edges according to the prior art have to be moved a long distance in a machining of a crankshaft, so that a total bearing region can be subjected to chip removal. This in turn means that processing times for the production of bearing regions of a crankshaft are long, which is undesirable from an economical point of view.

This is where the invention starts. The object of the invention is to disclose an end mill of the type mentioned at the outset in which the above disadvantages are eliminated at least in part.

Another object of the invention is to disclose the use of an insert.

Furthermore, one object of the invention is to disclose a method of the type mentioned at the outset, in which the above disadvantages are eliminated at least in part.

The object of disclosing an end mill of the type mentioned at the outset in which the disadvantages of the prior art are eliminated at least in part is attained with a generic end mill when the inserts in each case have at least one cutting edge which comprises alternately active cutting regions and non-active cutting regions.

The advantages achieved with an end mill according to the invention are to be seen in particular in that, due to the provided embodiment of the inserts, low cutting forces and favorable chip removal conditions are given, because compared to straight edges or cutting edges that are active cutting throughout, thicker chips can be removed with the same dimension of a chip cross section, which leads to a smaller cutting resistance or small cutting forces. This means that an undesirably high temperature development with a use of an end mill or a crankshaft machining is avoided, whereby in turn the end mill or a processing machine in which this is fixed is less stressed.

In order to be able to keep cutting forces particularly small, it is preferably provided that the inserts have cutting teeth, wherein the cutting teeth can be embodied with first cutting edge regions and second cutting edge regions, which in particular are part of wavy cutting edge courses of the inserts.

Since the cutting forces are small with an end mill according to the invention, in particular it can also be provided that the inserts in plan view are arranged on the end face such that the cutting edge courses of the inserts, with the exception of an opening optionally provided in the end face, essentially cover an entire radius of the end face in an overlapping manner. This means that to process an entire bearing region of a crankshaft, the end mill at most has to be moved only to a small extent to the left or right in order to be effective along an entire region in a chip-removing manner, since through the overlapping arrangement of the inserts or cutting edges as a rule the entire bearing region, with the exception of the opening optionally provided in the end face, is covered anyway, since end mills usually are dimensioned to fit with respect to a dimension of bearing regions to be processed repeatedly. A working time to process a bearing region of a crankshaft can therefore be kept short.

It is expedient that the inserts have an identical wavy cutting edge course, so that the favorable chip removal conditions with a turn milling are given for all inserts. However, in addition to the inserts designed for a turn milling, at least one finishing plate can also be provided in order to machine a bearing region of a crankshaft even more finely, at the same time with a turn milling. In principle, the first cutting edge regions as well as the second cutting edge regions can be embodied as desired. For example, the first cutting edge regions as well as the second cutting edge regions can run in a curved manner, wherein the radii are different. However, it is preferably provided that the inserts are embodied in front view with horizontal first cutting edge regions, which in particular merge into obliquely adjoining straight second cutting edge regions, whereby for both types of cutting edge regions favorable chip removal conditions are given. Furthermore, horizontal first cutting edge regions lead to a high quality of a processed surface. In connection therewith it can be provided that the second cutting edge regions adjoin the first cutting edge regions at an angle of about 30° to 60°, preferably about 40° to 50°. In order to avoid any chipped spots on the cutting edges as far as possible, with straight cutting edge regions it can be provided that the first cutting edge regions merge via an arc into the second cutting edge regions.

It is advantageously provided that the first cutting edge regions of the inserts with respect to a virtual reference plane running parallel to the end face which in principle corresponds to a plane in which a bearing region of a crankshaft is processed, are arranged on or in the end face with positive cutting geometry, which in turn is favorable in particular with reference to advantageous chip removal conditions or small cutting forces.

The inserts used with an end mill according to the invention can be embodied in principle with any geometric shape. However it is particularly preferably provided that the inserts are embodied in a rhombic shape in plan view. In this case it is avoided that the cutting teeth, which can extend over an entire length of the inserts depending on the insert embodiment, lead to larger cutting forces. Instead, a rhombic embodiment of the inserts ensures that a removed chip can be executed well and an insert does not “press”, in the technical terminology, from behind against the material machined or to be machined, which requires greater cutting forces. It is even more important that in this case a wedge angle of less than 90° is given for the first cutting edge regions as well as for the second cutting edge regions, which leads to favorable chip removing conditions. Since the inserts used with an end mill according to the invention are preferably indexable inserts, it can be provided that the inserts are respectively embodied with side surfaces which are tilted with respect to an essentially horizontal top or bottom of the insert, wherein side surfaces that help to define the cutting teeth recede from the top to the bottom, whereas the other side surfaces project from the top to the bottom. This means that the inserts advantageously arranged with positive cutting geometry respectively have sufficient relief angle for favorable chip removal conditions. The referenced positive cutting geometry hereby refers to geometric conditions at the inserts in the attached state.

It can occur with an end mill according to the invention that during the machining of a bearing region of a crankshaft a wavy contour is left in the machined bearing region after machining. This is at least largely avoided if the cutting teeth or the first cutting edge regions and second cutting edge regions of the inserts in plan view of the end face lie on a spiral running from an outside of the end face to a center of the end face. This measure ensures that the individual chip cross sections, seen in the direction of a radius of the end face, overlap as it were, so that an essentially smooth surface is obtained in the machining of a bearing region of a crankshaft. Depending on the arrangement or overlapping of the cutting teeth and/or the contour thereof, in addition one or two larger finishing plates with straight cutting edges can be arranged on or in the end face, in order to further improve a machining quality of the bearing region, which is optional, however. If provided, the finishing plates are arranged such that they jointly cover a radius of the end face, in turn with the exception of an opening in the end face.

The further object of the invention is attained by the use of an insert for an end mill for machining a bearing region of a crankshaft, in particular a crankshaft of a ship's engine, wherein the insert has at least one cutting edge, which in some sections comprises alternately active cutting regions and non-active cutting regions.

Preferably, the insert has cutting teeth, advantageously with first cutting edge regions and second cutting edge regions, which in particular are part of a wavy cutting edge course of the insert.

Through a use according to the invention of an insert, with a use of an end mill during a machining of a bearing region of a crankshaft large cutting forces can be restrained and favorable chip removal conditions can be achieved. The use according to the invention of an insert therefore also means that a temperature development is kept low during a machining of a bearing region of a crankshaft, which is also favorable.

It is preferably provided that the insert in front view is embodied with horizontal first cutting edge regions, which in particular merge into obliquely adjoining straight second cutting edge regions, which promotes favorable chip removal conditions. In connection therewith, it can be provided in particular that the second cutting edge regions adjoin the first cutting edge regions at an angle of approx. 30° to 60°, preferably approx. 40° to 50°.

The first cutting edge regions can merge via an arc into the second cutting edge regions, which is preferred with respect to a stability of the insert or a prevention of chipped spots in the insert.

The insert is preferably embodied to be rhombic in plan view, wherein the insert is embodied with side surfaces which are tilted with respect to an essentially horizontal top or bottom of the insert, wherein the side surfaces that help to define the cutting teeth recede from the top to the bottom, whereas the other side surfaces project from the top to the bottom. This type of embodiment of the insert when the same is used in an end mill leads to small cutting forces or favorable chip removal conditions. The insert is thereby advantageously embodied as an indexable insert, wherein in plan view a cutting edge course on the top of the insert intersects with a cutting edge course on the bottom of the insert approximately at an angle of 75° to 87°.

The further object of the invention is achieved in that an end mill according to the invention is used with a method of the type referenced at the outset.

One advantage achieved with a method according to the invention is to be seen in that cutting forces can be kept low with a use of the end mill and favorable chip removal conditions are given. In particular a large temperature development is avoided during a machining of a workpiece such as a crankshaft, which also benefits a gentle treatment of the tool.

One particular advantage of a method according to the invention lies in that the bearing region of the crankshaft during a single rotation of the same about the longitudinal axis thereof can be completely machined by turn milling, so that the method according to the invention is particularly efficient or economical.

Further features, advantages and effects of the invention are shown by the exemplary embodiment of the same described below. The drawings show:

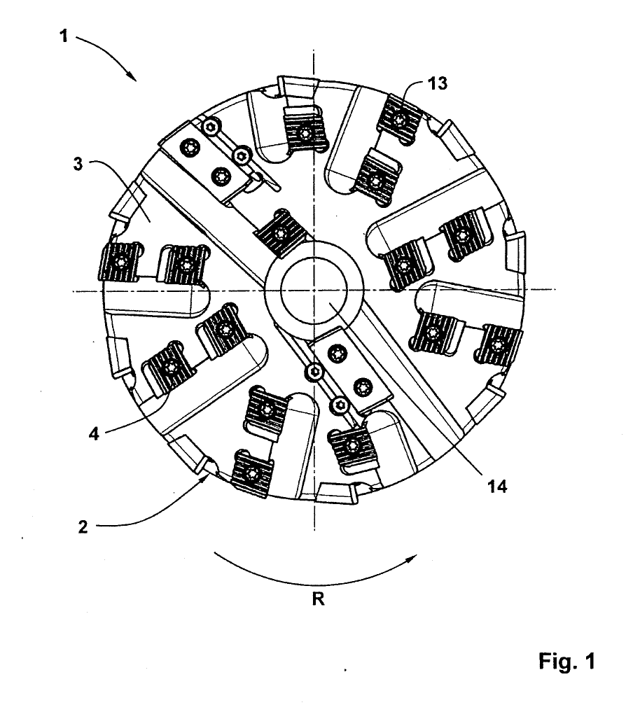

FIG. 1 An end mill in plan view;

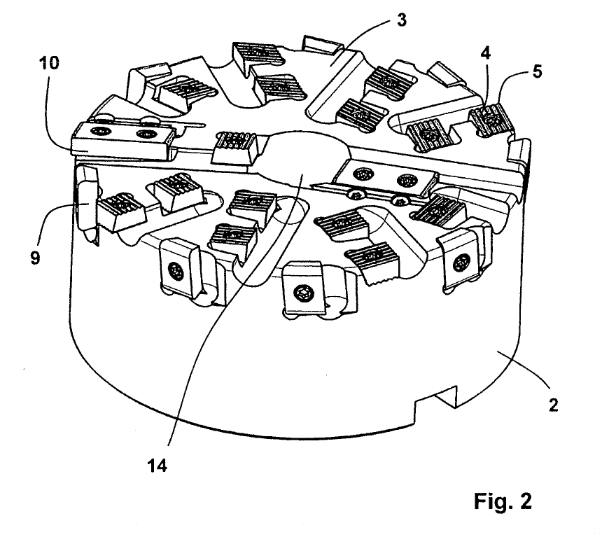

FIG. 2 A part of an end mill in perspective view;

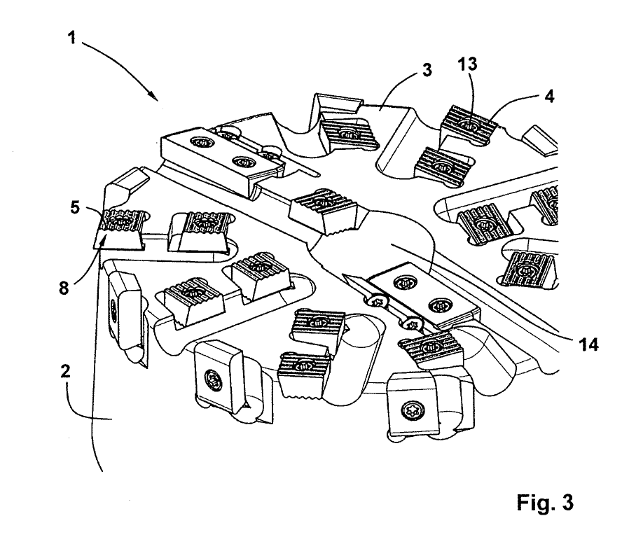

FIG. 3 A further perspective (partial) representation of a part of an end mill;

FIG. 4 A perspective representation of an insert;

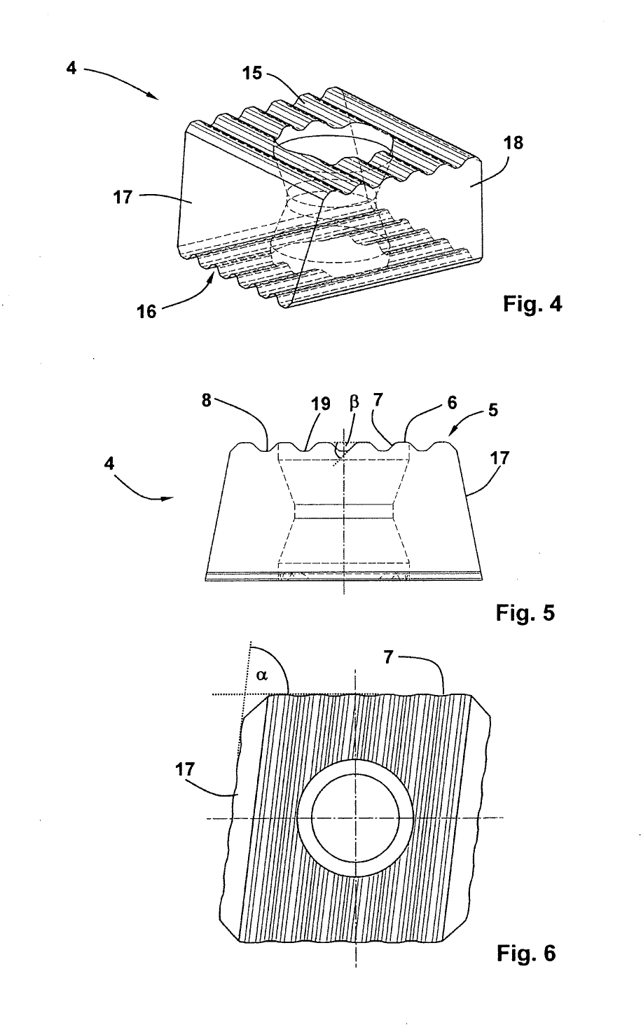

FIG. 5 A front view of an insert according to FIG. 4;

FIG. 6 A plan view of an insert according to FIG. 4;

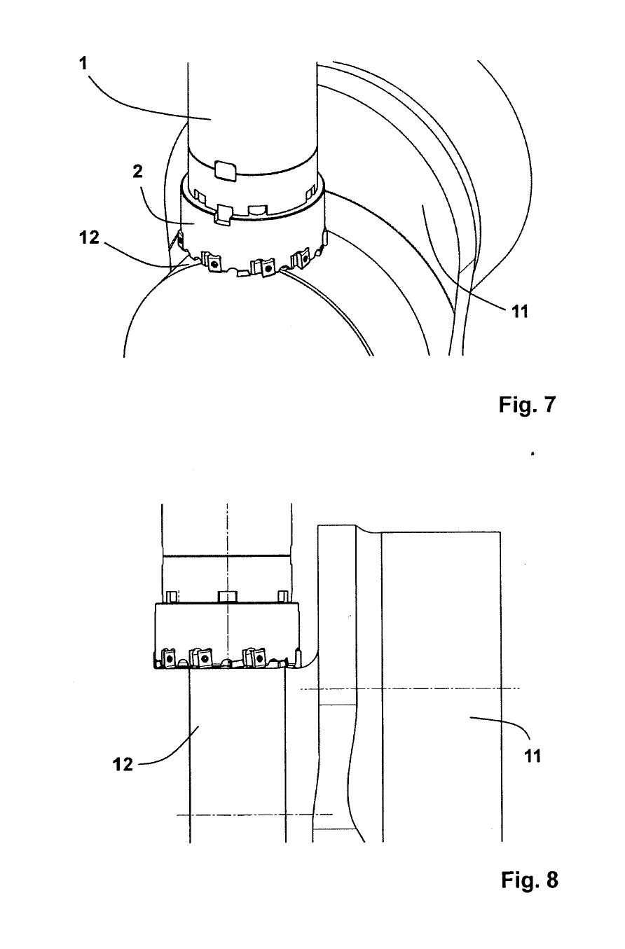

FIG. 7 A perspective representation of a machining of a crankshaft by means of end mill;

FIG. 8 A front view of an end mill during a machining of a crankshaft;

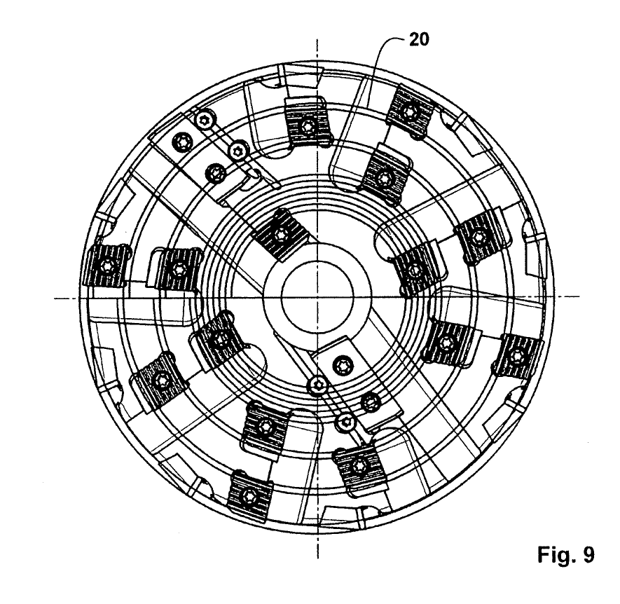

FIG. 9 A diagrammatic representation regarding a spiral-shaped arrangement of individual cutting teeth of different inserts;

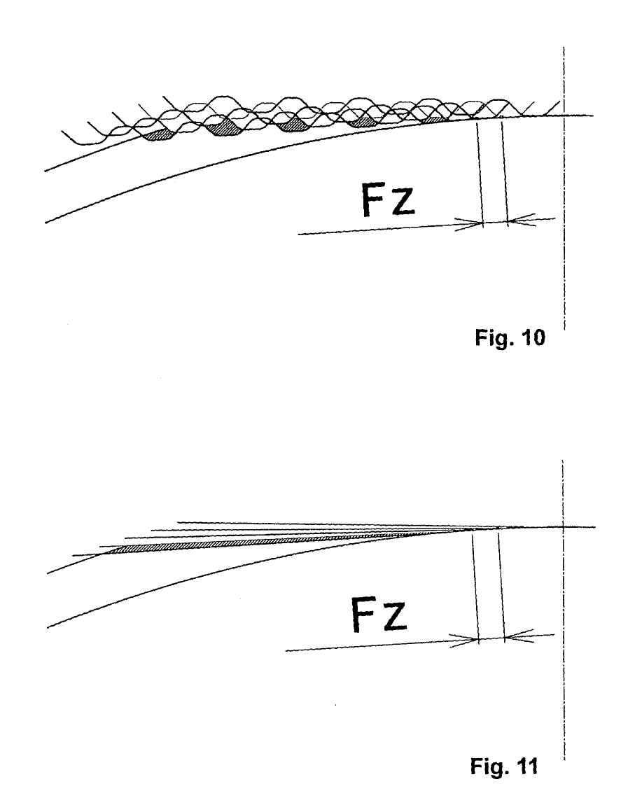

FIG. 10 Chip cross sections that are removed with an end mill according to the invention during a machining of a bearing region of a crankshaft;

FIG. 11 Chip cross sections that are removed with an end mill with inserts with continuously straight cutting edges during a machining of a bearing region of a crankshaft.

FIGS. 1 through 3 show an end mill 1 according to the invention in plan view and/or in perspective views, wherein only a part of the end mill 1 is shown in FIG. 3. The end mill 1 comprises a base body 2, which is embodied essentially cylindrically. The base body 2, as can be seen in FIG. 2, can be embodied as an insert, which is arranged on a shank of the end mill 1, wherein within the scope of the connection of the shank with the base body 2 damping means can be provided. In order to be able to arrange the base body 2 on the shank of the end mill 1, preferably an opening 14 is provided, through which a screw or another fastening means can be guided for the purpose of attachment of the base body 2 on the shank. The base body 2 has an end face 3, which is embodied to be essentially flat, unless insert seats and chip grooves are provided. Several types of inserts 4, 9, 10 are arranged on or in the end face 3. On the one hand inserts 4 designed for a turn milling are attached on or in the end face 3 of the base body 2. The inserts 4 each have a central through hole, through which a screw 13 or a mounting bolt can be guided, with which the inserts 4 are attached on or in the end face 3 of the base body 2. On the other hand, two finishing plates 10 are arranged on or in the end face 3. Furthermore, as can be seen in FIG. 2, for example, so-called radial inserts 9 can also be arranged on the outside of the base body 2, which are used for machining a radius, if necessary. The end mill 1 rotates in the direction R according to FIG. 1.

The inserts 4 are embodied as shown in FIGS. 4 through 6. Each insert 4 is composed of an optionally coated hard metal, which is shaped to form an insert 4 that is rhombic in plan view. The insert 4 has a horizontal or essentially horizontal top 15 as well as a like bottom 16, which are connected to one another by flat side surfaces 17, 18. The side surfaces 17 project in plan view of the insert 4 to the bottom 16 of the insert 4, whereas the side surfaces 18, which, like the side surfaces 17, connect the top 15 to the bottom 16, are embodied in a receding manner. The insert 4 has the already mentioned central opening, through which one of the screws 13 or another fastening means can be guided in order to attach the insert 4 in particular to an end mill 1. The insert 4 has on the top 15 as well as on the bottom 16 a cutting edge course 8, which is also defined by the side surfaces 18. The cutting edge course 8, which can be clearly seen in the front view according to FIG. 5, comprises cutting teeth 5 with respectively active cutting first cutting edge regions 6 and second cutting edge regions 7 as well as edge sections 19 lying recessed between them, which are not cutting active. The cutting teeth 5 are thereby embodied with respect to the entire top 15 or bottom 16 of the insert 4 such that a groove-shaped profile is given on the top 15 or bottom 16, although this is not mandatory. An angle that is enclosed between the top 15 and one of the side surfaces 18 of the insert 4 is typically approx. 5° to 15°, in particular 7° to 13°, so that a favorable relief angle is given for the first cutting edge regions 6. An angle α between side surfaces 17 and side surfaces 18 is preferably approx. 75° to 87°, in particular 80° to 86°. An angle β at which the second cutting edge regions 7 adjoin the first cutting edge regions 6, can be, e.g., 30° to 60°, preferably 40° to 50°. As can be seen in FIG. 4, the wavy cutting edge course 8 with the cutting teeth 5 on the top 15 and the bottom 16 is embodied such that the visible grooves and ribs intersect when these are imagined arranged one on top of the other. An intersection angle corresponds to the already mentioned angle α between the side surfaces 17 and the side surfaces 18.

Several of the inserts 4 are arranged on or in the end face 3 of the base body 2 of the end mill 1, as can be see in FIG. 1, in the radial direction, wherein the individual inserts 4 are arranged in pairs next to one another and offset radially with respect to one another with cutting edge courses 8 aligned towards the center of the opening 14, so that ultimately in the radial direction an entire radius of the end face 3 is covered by the inserts 4, when the end mill 1 or base body 2 rotates in operation. This is the case, for example, as can be seen based on FIGS. 7 and 8, in the machining of a bearing region 12 of a crankshaft 11 or of a blank thereof. The crankshaft 11 is thereby turned about a longitudinal axis of the same, while the end mill 1 or base body 2 likewise rotates and at the same time is moved over the bearing region 12 to be machined. In contrast to the prior art, however, a movement of the end mill 1 along the longitudinal axis of the crankshaft 11 can be kept to a minimum, since the end mill 1 seen in the radial direction, is equipped with inserts 4 so far that only the free region of the opening 14, which cannot be machined with simple placement, is also covered by the movement. The individual inserts 4 are not simply offset with respect to one another in the radial direction, but also arranged such that individual cutting teeth 5 of different inserts 4 lie on a spiral 20, which runs from an outside of the base body 2 towards a center of the same. This situation is shown in FIG. 9, wherein for the sake of clarity the base body 2 is masked and the spiral 20 is shown merely in part. This spiral-shaped arrangement means that the individual cutting teeth 5 essentially overlap during the rotation of the end mill 1, so that a bearing region 12 of a crankshaft 11 can be produced with an acceptable smoothness. For this the inserts 4 are offset along the spiral 20 in each case with consistent spacing and in each case several millimeters further radially inwards with respect to an insert 4 previously arranged on the spiral 20. If the individual cutting teeth 5 do not perfectly overlap, two finishing plates 10 can also be provided, which remove any overhangs on the bearing region 12. The number of finishing plates 10, which as already mentioned can be optionally provided, is minimized in order not to increase necessary cutting forces beyond an acceptable level. Preferably, as shown for example in FIG. 2, two finishing plates 10 are provided, which are offset relative to one another or with reference to a radius of the end face 3 such that the two finishing plates 10 with the exception of the opening 14 cover a radius of the end face 3, when these are imagined arranged one behind the other.

If the arrangement of the inserts 4 shown in FIG. 9 is used, chip cross sections as shown in FIG. 10 result, wherein Fz means a distance between individual cutting teeth 5 of different inserts 4. As can be seen, the wavy cutting edge course 8 of the inserts 4 means that a similar mass compared to a flat cutting edge is removed from a machined crankshaft 11, wherein however, a chip cross section is markedly different. In this context it is decisive that the cutting forces with a chip cross section according to FIG. 10 are much smaller than with a chip cross section according to FIG. 11, thus in general more favorable chip removal conditions are given, which lead to the advantages already explained.

1. An end mill (1) for processing a bearing region (12) of a crankshaft (11), in particular a crankshaft (11) of a ship's engine, with a base body (2) with an end face (3) and several inserts (4) designed for a turn milling, which are arranged on or in the end face (3), characterized in that the inserts (4) have at least one cutting edge which comprises alternately active cutting regions and non-active cutting regions.

2. The end mill (1) according to claim 1, characterized in that the inserts (4) have cutting teeth (5).

3. The end mill (1) according to claim 2, characterized in that the cutting teeth (5) are embodied with first cutting edge regions (6) and second cutting edge regions (7).

4. The end mill (1) according to claim 3, characterized in that the first cutting edge regions (6) and second cutting edge regions (7) are part of wavy cutting edge courses (8) of the inserts (4).

5. The end mill (1) according to claim 4, characterized in that the inserts (4) in plan view are arranged on the end face (3) such that the cutting edge courses (8) of the inserts (4), with the exception of an opening (14) optionally provided in the end face (3), essentially cover an entire radius of the end face (3) in an overlapping manner.

6. The end mill (1) according to claim 4, characterized in that the inserts (4) have an identical wavy cutting edge course (8).

7. The end mill (1) according to claim 1, characterized in that the inserts (4) are embodied in front view with horizontal first cutting edge regions (6), which in particular merge into obliquely adjoining straight second cutting edge regions (7).

8. The end mill (1) according to claim 7, characterized in that the second cutting edge regions (7) adjoin the first cutting edge regions (6) at an angle (β) of about 30° to 60°, preferably about 40° to 50°.

9. The end mill (1) according to claim 7, characterized in that the first cutting edge regions (6) merge via an arc into the second cutting edge regions (7).

10. The end mill (1) according to claim 3, characterized in that the first cutting edge regions (6) of the inserts (4) with respect to a virtual reference plane running parallel to the end face (3) are arranged on or in the end face (3) with positive cutting geometry.

11. The end mill (1) according to claim 3, characterized in that the inserts (4) are embodied in a rhombic shape in plan view.

12. The end mill (1) according to claim 11, characterized in that the inserts (4) are respectively embodied with side surfaces (17, 18) which are tilted with respect to an essentially horizontal top (15) or bottom (16) of the insert (4), wherein side surfaces (18) that help to define the cutting teeth (5) recede from the top (15) to the bottom (16), whereas the other side surfaces (17) project from the top (15) to the bottom (16).

13. The end mill (1) according to claim 3, characterized in that the cutting teeth (5) or the first cutting edge regions (6) and second cutting edge regions (7) of the inserts (4) in plan view of the end face (3) lie on a spiral (20) running from an outside of the end face (3) to a center of the end face (3).

14. A use of an insert (4) for an end mill (1) for machining a bearing region (12) of a crankshaft (11), in particular a crankshaft (11) of a ship's engine, wherein the insert (4) has at least one cutting edge, which in some sections comprises alternately active cutting regions and non-active cutting regions.

15. The use according to claim 14, wherein the insert (4) has cutting teeth (5).

16. The use according to claim 15, wherein the cutting teeth (5) are embodied with first cutting edge regions (6) and second cutting edge regions (7).

17. The use according to claim 16, wherein the first cutting edges (6) and second cutting edges (7) are part of a wavy cutting edge course (8) of the insert (4).

18. The use according to claim 16, wherein the insert (4) in front view is embodied with horizontal first cutting edge regions (6), which in particular merge into obliquely adjoining straight second cutting edge regions (7).

19. The use according to claim 18, wherein the second cutting edge regions (7) adjoin the first cutting edge regions (6) at an angle (β) of approx. 30° to 60°, preferably approx. 40° to 50°.

20. The use according to claim 18, wherein the first cutting edge regions (6) merge via an arc into the second cutting edge regions (7).

21. The use according to claim 16, wherein the insert (4) is embodied to be rhombic in plan view.

22. The use according to claim 21, wherein the insert (4) is embodied with side surfaces (17, 18), which are tilted with respect to an essentially horizontal top (15) or bottom (16) of the insert (4), wherein the side surfaces (18) that help to define the cutting teeth (5) recede from the top (15) to the bottom (16), whereas the other side surfaces (17) project from the top (15) to the bottom (16).

23. The use according to claim 21, wherein the insert (4) is embodied as an indexable insert, wherein in plan view a cutting edge course (8) on the top (15) of the insert (4) intersects with a cutting edge course (8) on the bottom (16) of the insert (4) approximately at an angle (α) of 75° to 87°.

24. A method for machining a bearing region (12) of a crankshaft (11), in particular a crankshaft (11) of a ship's engine, wherein an end mill (1) is placed against a clamped crankshaft (11) in rotation, in order to machine a bearing region (12) of a predetermined dimension through a turn milling, characterized in that an end mill (1) according to claim 1 is used.

25. The method according to claim 24, characterized in that the bearing region (12) of the crankshaft (11) during a single rotation of the same about the longitudinal axis thereof is completely machined by turn milling.
